(19) United States
(12) Patent Application Publication
(10) Pub. No.: US 2016/0125028 A1
(43) Pub. Date: May 5, 2016

(54) SYSTEMS AND METHODS FOR QUERY REWRITING

(71) Applicant: Yahoo! Inc., Sunnyvale, CA (US)

(72) Inventors: Fabrizio Silvestri, Barcelona (ES); Mihajlo Grbovic, Mountain View, CA (US); Narayan Bhamidipati, Sunnyvale, CA (US); Vladan Radosavljevic, Sunnyvale, CA (US); Nemanja Djuric, Mountain View, CA (US)

(21) Appl. No.: 14/533,405

(22) Filed: Nov. 5, 2014

(51) Int. Cl. G06F 17/30

(52) U.S. Cl. CPC G06F 17/30448; G06F 17/30592; G06F 17/30324

(57) ABSTRACT

Systems and methods for rewriting query terms are disclosed. The system collects queries and query session data and separates the queries into sequences of queries having common sessions. The sequences of queries are then input into a deep learning network to build a multidimensional word vector in which related terms are nearer one another than unrelated terms. An input query is then received and the system matches the input query in the multidimensional word vector and rewrites the query using the nearest neighbors to the term of the input query.

### BACKGROUND

1. Technical Field

The disclosed embodiments are related to internet advertising and more particularly to systems and method for rewriting queries in a search ad marketplace.

2. Background

Internet advertising is a multi-billion dollar industry and is growing at double-digit rates in recent years. It is also the major revenue source for internet companies such as Yahoo!® that provide advertising networks that connect advertisers, publishers, and Internet users. As an intermediary, these companies are also referred to as advertiser brokers or providers. New and creative ways to attract attention of users to advertisements (“ads”) or to the sponsors of those advertisements help to grow the effectiveness of online advertising, and thus increase the growth of sponsored and organic advertising. Publishers partner with advertisers, or allow advertisements to be delivered to their web pages, to help pay for the published content, or for other marketing reasons.

Search engines assist users in finding content on the Internet. In the search ad marketplace, ads are displayed to a user alongside the results of a user's search. Ideally, the displayed ads will be of interest to the user resulting in the user clicking through an ad. In order to increase the likelihood of a user clicking through the ad, an ad may be selected for display by matching terms contained in the search with the ad. Such systems work well in many situations, but in other situations a limited number or even no ads may match the terms of the search. To combat this problem, query rewriting is often used to broaden the number of ads matched to the query terms. In query rewriting, the search terms are rewritten into related terms based on a goal such as relevance.

As an example consider the query “Brad Pitt”. This query has low chances of retrieving ads (unless advertisers have bid on those keywords) and therefore one could think of rewriting it into related queries that have higher chances of retrieving relevant ads. For instance, “Brad Pitt” could be rewritten into the query “diesel sunglasses cobretti” that is still related to Brad Pitt but with a higher likelihood of retrieving a relevant ad which could lead to a user click.

In the past, many methods have been proposed for rewriting queries, and they are mostly based on graphs (i.e., the Query Flow Graph) and simple syntactical relationships between adjacent queries in users' query sessions. However, such approaches are generally not uses for rewriting queries in which queries do not co-occur.

Thus, there exists a technical problem of providing data in response to a query when an exact match with existing data does not occur. The particular context of the problem is described herein as a sponsored-search system in which there is no query-to-ad match. However, the solutions described herein may be readily extended to other database searching and query satisfaction systems.

### BRIEF SUMMARY

It would be beneficial to develop a system and methods that move beyond simple syntactical relationships to broaden the number of terms a query may be rewritten as includes queries that may be related in context, but that do not necessarily co-occur. If a larger number of terms are found for rewriting that are still relevant to the original query, it will increase the opportunities to match advertisements to a user query.

In one aspect, an embodiment for of a computing system for rewriting queries is disclosed. The computing system includes an input module configured to receive a plurality of queries and session information for each of the queries; a learning module configured to embed terms contained in the plurality of queries in a multidimensional word vector, wherein terms having a similar context in a session are near each other in the multidimensional word space; and a query rewrite module configured to receive a query, find the nearest neighbors of terms within the query in the multidimensional word vector, and rewrite the query with the nearest neighbors of the term.

In some embodiments, the plurality of queries and session information include at least one document having of a string of uninterrupted queries ordered temporally by a user. In some embodiments, a string of uninterrupted queries is defined as an uninterrupted sequence of web search activity by a user that ends when the user is inactive for more than 30 minutes. In some embodiments, the nearest neighbor is found using a cosine distance metric.

In some embodiments, the input module is further configured to group queries among the plurality of queries into documents made up of a string of uninterrupted queries ordered temporally by a user. In some embodiments, the learning module operates on the plurality of word sequences in a sliding window fashion. In some embodiments, each sequence of words is a context.

In another aspect, an embodiment of a method for rewriting queries is disclosed. In the method a history of search query activity is accessed to obtain a plurality of queries and session data; queries from among the plurality of queries are grouped into documents, with all queries in a document having a common session; the documents are input into a deep learning network to embed terms from among the queries in a multidimensional word vector in which related terms are found close to one another; an input query is received; terms in the input query are located within the multidimensional word vector; a plurality of nearest neighbor terms to the input terms are found in the multidimensional word vector; and the input query is rewritten into a modified query containing the plurality of nearest neighbor terms.

In some embodiments, finding a plurality of nearest neighbor terms includes determining nearest neighbors through a cosine distance metric. In some embodiments, the multidimensional word vector has greater than 200 dimensions.

In another aspect, an embodiment of a computer program product for rewriting queries is disclosed. The computer program product includes non-transient computer readable storage media have instructions stored thereon that cause a computing device to perform a method. The method includes receiving a query comprising a query term; accessing a multidimensional word vector of interconnected query words to find a plurality of related query words spatially near the query in the multidimensional word vector; and rewriting the query with the plurality of related words.

In some embodiments, the multidimensional word vector is an output of a deep learning network trained with a plurality of word sequences with each word sequence comprising query terms from a continuous query session. In some embodiments, the instructions further cause the computing device to build the multidimensional word vector. In some embodiments, building the multidimensional word vector includes collecting a plurality of query terms having associated session data; grouping query terms from among the plurality of query terms according to session data to form term sequences; and inputting the term sequences into a deep learning network to embed each term in a multidimensional word vector in which related terms are found close to one another. In some embodiments, the query comprises a multi-word phrase.

### BRIEF DESCRIPTION OF THE DRAWINGS

FIG. 1 illustrates an exemplary embodiment of a network system suitable for practicing the invention.

FIG. 2 illustrates a schematic of a computing device suitable for practicing the invention.

FIG. 3 illustrates a high level system diagram of a system rewriting queries.

FIG. 4 illustrates a flowchart of a method for rewriting queries.

FIG. 5 illustrates a flowchart of a method for building a multiword vector for use in rewriting queries.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, the disclosed embodiments relate to systems and methods for rewriting queries. The systems and methods are able to rewrite queries into terms that may not be available using traditional query rewriting techniques based on simple syntactical relationships between queries. In the system for rewriting queries, a user enters a search query at a client device. The search query is sent to a search engine and the search engine may return search results related to the query for display on a search results page at the client device. Additionally, the query may be sent to an ad network, which delivers ads for display on the search result page at the client device. The ads for display are matched based on the text of the query and any additional terms that the query may be rewritten to.

### Network

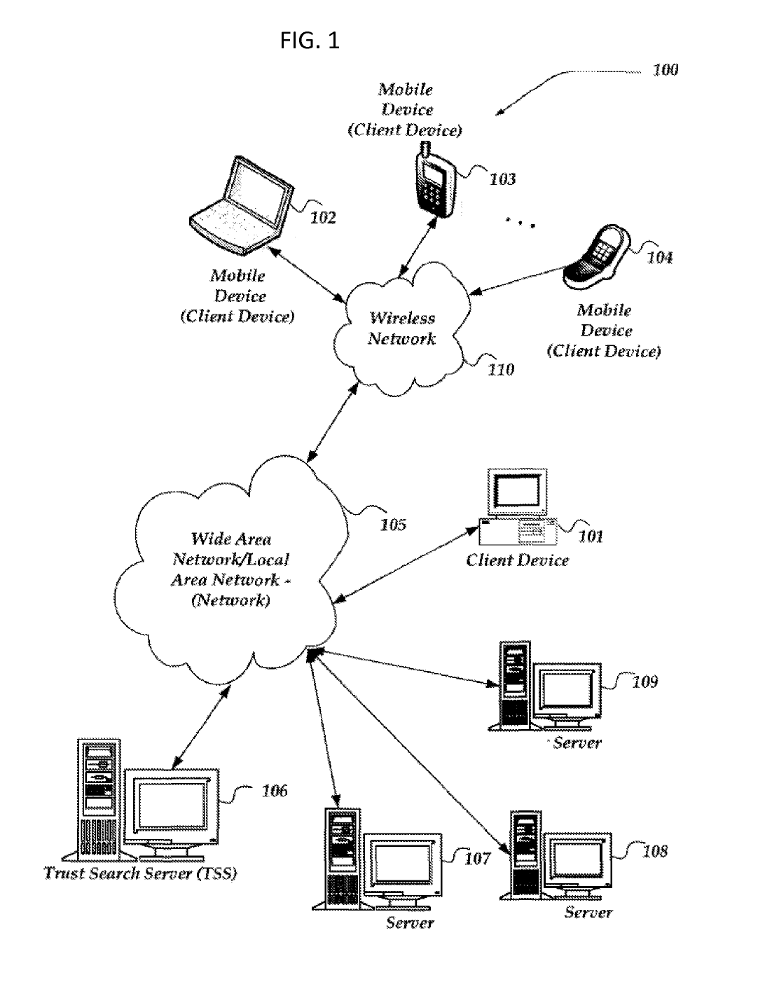

FIG. 1 is a schematic diagram illustrating an example embodiment of a network 100 suitable for practicing the claimed subject matter. Other embodiments may vary, for example, in terms of arrangement or in terms of type of components, and are also intended to be included within claimed subject matter. Furthermore, each component may be formed from multiple components. The example network 100 of FIG. 1 may include one or more networks, such as local area network (LAN)/wide area network (WAN) 105 and wireless network 110, interconnecting a variety of devices, such as client device 101, mobile devices 102, 103, and 104, servers 107, 108, and 109, and search server 106.

The network 100 may couple devices so that communications may be exchanged, such as between a client device, a search engine, and an ad server, or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

### Computing Device

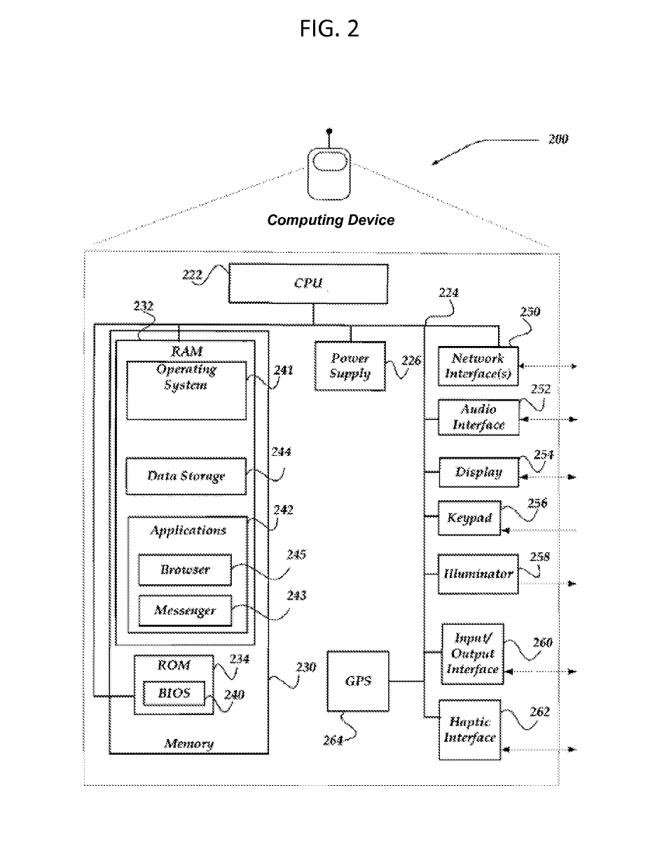

FIG. 2 shows one example schematic of an embodiment of a computing device 200 that may be used to practice the claimed subject matter. The computing device 200 includes a memory 230 that stores computer readable data. The memory 230 may include random access memory (RAM) 232 and read only memory (ROM) 234. The ROM 234 may include memory storing a basic input output system (BIOS) 230 for interfacing with the hardware of the client device 200. The RAM 232 may include an operating system 241, data storage 244, and applications 242 including a browser 245 and a messenger 243. A central processing unit (CPU) 222 executes computer instructions to implement functions. A power supply 226 supplies power to the memory 230, the CPU 222, and other components. The CPU 222, the memory 230, and other devices may be interconnected by a bus 224 operable to communicate between the different components. The computing device 200 may further include components interconnected to the bus 224 such as a network interface 250 that provides an interface between the computing device 200 and a network, an audio interface 252 that provides auditory input and output with the computing device 200, a display 254 for displaying information, a keypad 256 for inputting information, an illuminator 258 for displaying visual indications, an input/output interface 260 for interfacing with other input/output devices, haptic feedback interface 262 for providing tactile feedback, and a global positioning system 264 for determining a geographical location.

### Client Device

A client device is a computing device 200 used by a client and may be capable of sending or receiving signals via the wired or the wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features and need not contain all of the components described above in relation to a computing device. Similarly, a client device may have other components that were not previously described. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

### Servers

A server is a computing device 200 that provides services, such as search services, indexing services, file services, email services, communication services, and content services. Servers vary in application and capabilities and need not contain all of the components of the exemplary computing device 200. Additionally, a server may contain additional components not shown in the exemplary computing device 200. In some embodiments a computing device 200 may operate as both a client device and a server.

### Deep Learning Networks in Non Linear Programming (NLP)

Language models play an important role in many NLP applications, especially in information retrieval. Traditional language model approaches represent a word as a feature vector using a one-hot representation—the feature vector has the same length as the size of the vocabulary, where only one position that corresponds to the observed word is switched on. However, this representation suffers from data sparsity. For words that are rare, corresponding parameters will be poorly estimated.

Inducing low dimensional embeddings of words by neural networks has significantly improved the state of the art in NLP. Typical neural network based approaches for learning low dimensional word vectors are trained using stochastic gradient via back propagation. Historically, training of neural network based language models has been slow, which scales as the size of the vocabulary for each training iteration. A recently proposed scalable continuous Skip-gram deep learning model for learning word representations has shown promising results in capturing both syntactic and semantic word relationships in large news articles data.

The Skip-gram model is designed to train a model that can find word representations that are capable of predicting the surrounding words in a document. The model accounts for both query co-occurrence and context co-occurrence. In particular, queries that co-occur often or frequently have similar contexts (i.e., surrounding queries) will be projected nearby in the new vector space. The skip-gram model may be applied to web search data, by ordering user's search queries temporally in time and splitting the queries into sessions that are treated as separate documents. The sessions may be defined as uninterrupted sequences of web search activity. An uninterrupted sequence of web activity may be defined as a user being active within in a defined duration of time. For example, a session may end when the user is inactive for more than 30 minutes. A new session would start with the next search query.

The training objective for the skip-gram model is stated as follows. Assume a sequence of words w₁, w₂, w₃, . . . , w_{T} in a document used for training, and denote by V the vocabulary, a set of all words appearing in the training corpus. The algorithm operates in a sliding window fashion, with a center word w and k surrounding words before and after the central word, which is referred to as context c. It is possible to use a window of different size. It may be useful to have a sequence of words forming a document in which each word within the document is related to one another. The window may then be each document such that all terms in a sequence are considered related, rather than just k surrounding words. This may be accomplished by using an infinite window for each document making up the training data. The parameters θ to be learned are the word vectors v for each of the words in the corpus.

At each step of the sliding window process the conditional probabilities of context are considered given the word [symbol] (c|w). For a single document, the parameters θ that maximize the document corpus probability, given as

$$arg max {\prod }_{t = 1}^{T} {\prod }_{- k \leq j \leq j \neq t} ℙ ( {w}_{t + j} \vert {w}_{t} ; θ )$$

Considering that training data may contain many documents, the global objective may be written as

$$arg max {\prod }_{( w , c ) ∈ D}^{T} ℙ ( c \vert w ; θ )$$

where D is the set of all word and context pairs in the training data.

Modeling the probability [symbol] (c|w, θ) may be done using a soft-max function, as is typically used in the neural-network language models. The main disadvantage of the presented solution is that it is computationally expensive, for example, in terms of a required number of processor cycles or memory storage requirements. The term [symbol] (c|w, θ) is very expensive to compute due to the summation over the entire vocabulary, therefore making the training complexity proportional to size of the training data that may contain hundreds of thousands of distinct words.

Significant training speed-up may be achieved when using a hierarchical soft-max approach. Hierarchical soft-max represents the output layer (context) as a binary tree with |V| words as leaves, where each word w may be reached by a path from the root of the tree. If n(w,j) is the j-th node on that path to word w, and L(w) is the path length, the hierarchical soft-max defines probability [symbol] (w|wᵢ) as

$$ℙ ( w \vert {w}_{i} ) = {\prod }_{j = 1}^{L ( w ) - 1} σ ( {v}_{n ( w , j )}^{T} \cdot {v}_{{w}_{i}} )$$

Where σ(x)=1/(1+exp(−x)). Then, the cost of computing the hierarchical soft-max approach is proportional to log |V|. In addition, the hierarchical soft-max skip-gram model assigns one representation v_{w} to each word, and one representation vₙ for every inner node n of the binary tree, unlike the soft-max model in which each word had context and word vectors v_{c} and v_{w}, respectively.

In the examples that follow, this general approach may be used with sequences of words derived from query sessions, as recorded in a search log. For example, a user at a client device, such as mobile device 102 may enter a query comprising a text phrase at the client device to search for a particular topic. The user may continue entering variations of the text phrase, or a related text. Each of these queries may be recorded in a query log along with related information such as an identifier for the user and a time stamp. This process is repeated for a large number of users and query sessions. The vocabulary for the model may be the entire set of words contained within the search log, or it may be a subset of words with unimportant or common words removed. Other approaches for training a model that finds word representations that are capable of predicting the surrounding words in a document may be used. For example, Word2vec, a popular open-source software, is readily available for training low dimensional word vectors. However, previous work, such as Word2vec, has focused in capturing word relationships with respect to everyday language. As such, the Word2vec tool is trained using a corpus of common web phrases, such as those found on Wikipedia.

### Overview

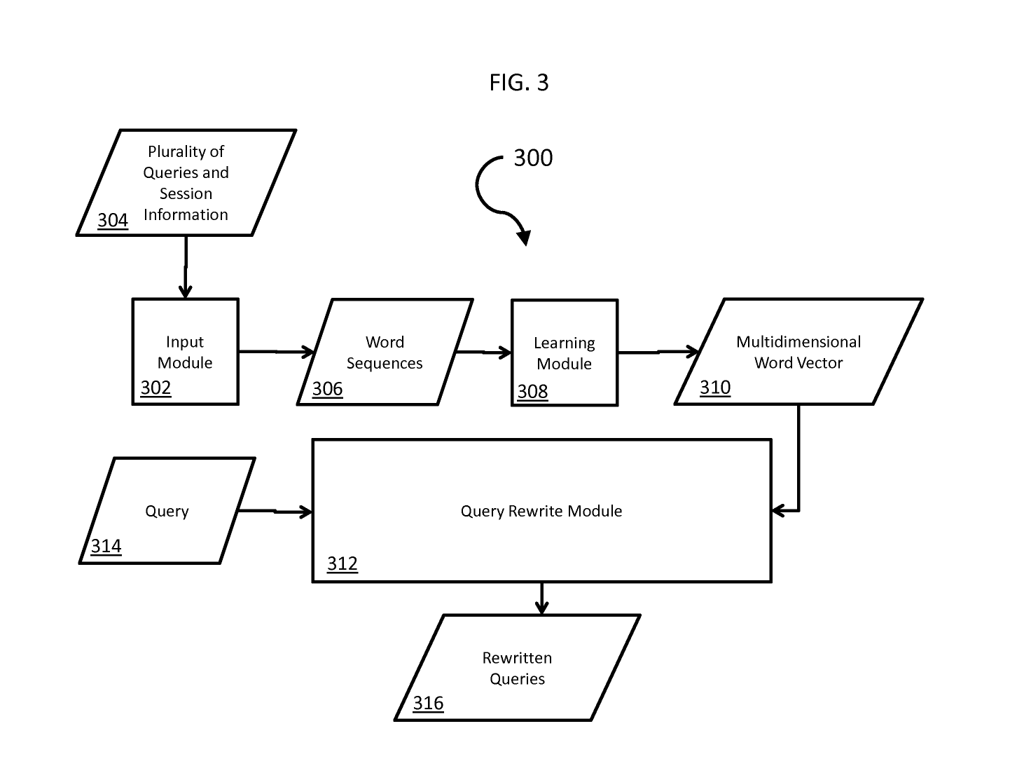

FIG. 3 illustrates a high level system diagram of a computing system 300 for rewriting queries. The system 300 may be executed as hardware or software modules on a computing device as shown in FIG. 2, for example, or as a combination of hardware and software modules. The modules may be executable on a single computing device or a combination of modules may each be executable on separate computing devices interconnected by a network. For example, a single sever, such as server 109 may execute each of the modules, receiving a query from client device and outputting the rewritten queries to an ad network. In another example, a combination of servers such as server 109, server 108, and server 107, could operate together with each server executing a module. Server 107 may receive session and query data from a search server such as Trust Search Server 106. Server 107 may then output word sequences to server 108 over network 105. Server 108 may generate a word vector using the word sequences and output the word vector to server 109. Server 109 may then receive a query over network 105 from a client device 102 and output query rewrites based on the word vector and query to an ad network over network 105. FIG. 3 illustrates a high level diagram of the system 300 with each module component being connected directly to one another, but they need not be. For example, each module could be connected to a communications bus to communicate between the modules. The arrows as shown on the diagram are for clarity in illustrating the general flow of data.

The input module 302 is configured to receive a plurality of queries and session information 304 for each of the queries. The plurality of queries may be a data file containing search log history information from which session identification may be derived. In some embodiments the plurality of queries may be preprocessed into word sequences having common sessions. The session information may be contained within a search log or may be information grouping word sequences. For example, the input module may receive a search log containing a queries along with information associating a user with a query and a time that a query was placed. The input module may then generate word sequences from a common query session based on the user association and timing data. For example, uninterrupted queries from a user may form a word sequence. In embodiments in which the data is preprocessed into word sequences, the input module may receive the data and pass it through to the next module.

The input module passes the word sequences 306 formed from the plurality of queries and session information 304 into a learning module 308. The learning module 308 is configured to embed terms contained in the plurality of word sequences 306 into a multidimensional word vector 310, in which related terms are found in close proximity. One example of an exemplary learning module 308 is the open source word2vec program. Other programs or applications may be used as well to achieve similar ends and provide additional benefits such as reduced data storage, faster processing, and so on. The learning module may find related words using a sliding window, as described previously, or it may treat each word sequence as a single document containing related terms. The multidimensional word vector 310 output from the learning module may have between two hundred and three hundred dimensions. The multidimensional word vector 310 may be generated and stored in memory for common access by other modules of the computing system. The potentially large number of dimensions of the multidimensional word vector 310 requires efficient processing and memory usage.

The multidimensional word vector 310 is input into a query rewrite module. The query rewrite module 312 is also configured to a query from a query 314 from a user. The query rewrite module 312 locates terms in the query 314 within the multidimensional word vector 310 and calculates the query's nearest neighbors. The nearest neighbors may be calculated using a common distance function such as a cosine distance metric. The top scoring neighbors are selected for rewriting the query. The number of top scoring members may be selected based on user preferences, a minimum score threshold, or other technique for selecting the number of terms to rewrite the query. The top scoring neighbors are then output as rewritten queries 316.

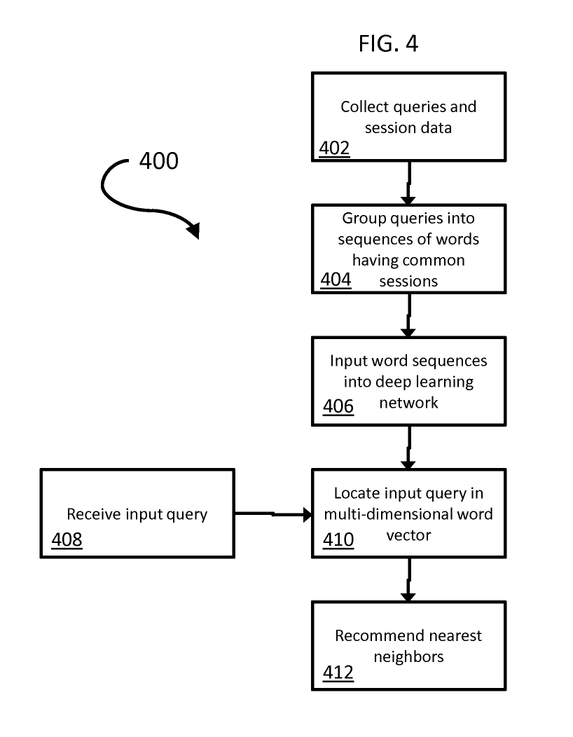

In another aspect, embodiments are further directed to a method for rewriting queries. The method may be performed using the system of FIG. 3. FIG. 4 illustrates a high level flowchart of a method 400 for rewriting queries. In the method 400, at block 402, a query and session data is collected. The plurality of query and session data may be collected by maintaining a historical record of queries, user information, and timing information, for instance at search engine 106. In other embodiments the query and session data may be collected by receiving a file containing the historical record, or it may be collected by receiving a file containing sequences of query terms of a common session. Input module 302 of system 300 may be responsible for collecting the query and session data.

In block 404, the queries are grouped into sequences of words having common sessions. For example, input module 302 of system 300 may evaluate session and query data to determine a session that each of the queries corresponds to. For example, input module 302 may separate the queries of the session and query data into queries by user, and then determine which queries are from a single continuous session. Then, for each session, the queries may have their corresponding words combined into a sequence of words. In other embodiments, the queries may be grouped previously, in which case block 404 would likely take place prior to block 402.

In block 406, the word sequences are input into a deep learning network configured to determine relationships between words. The deep learning network embeds words from among the word sequences in a multidimensional word vector in which relative strength of the relation between words is represented by the distance between words. The deep learning network may be the learning module 308 of FIG. 3. The result of inputting the word sequences into the deep learning network is a multidimensional word vector in which related terms are spatially near one another. The multidimensional word vector may have more than two hundred dimensions.

In block 408, an input query is received. The input query may be a phrase that is being searched by a user. In block 410, the terms of the input query are located in the multidimensional word vector. Once the terms of the input query are located in the multidimensional word vector, their nearest neighbors are found in block 412. The nearest neighbors may be determined using the query rewrite module 312 from FIG. 3. As described previously, the cosine distance metric may be used to determine the nearest neighbors. In block 314, the query is rewritten using the terms from the nearest neighbor.

In another embodiment, an alternative method 500 for rewriting queries terms is disclosed. The method 500 may be embodied as a computer program product for rewriting queries. The computer program product may comprise non-transient computer readable storage media, such as memory 222 of computing device 200, having instructions stored thereon that cause the computing device 200 to perform the method 500.

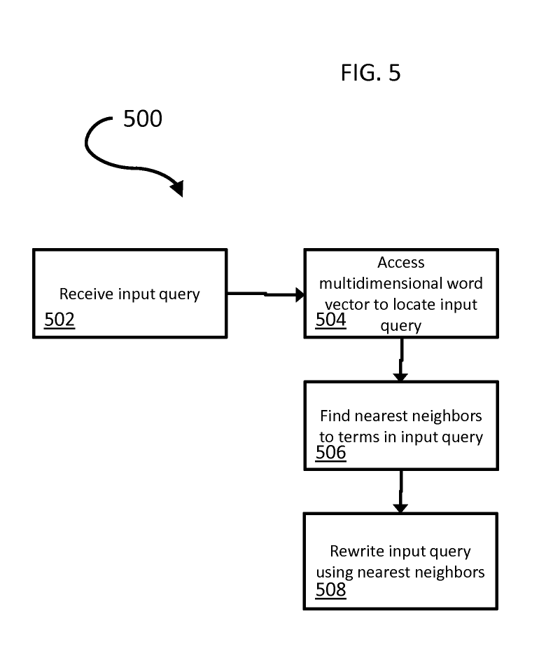

FIG. 5 is a high level flow chart of the embodiment of the method 500 for rewriting queries. This method may be performed in the query rewriting module of FIG. 3. In block 502, an input query is received. In block 504, a multidimensional word vector of interconnected query terms is accessed to find a plurality of nearest neighbors. In block 506, the input query is rewritten using the nearest neighbor terms. The multidimensional word vector may comprise an output of a deep learning network trained with sessionized query term sequences.

The method may further comprising building the multidimensional word vector. The multidimensional word vector may be built by collecting a plurality query terms having associated session data, grouping query terms based on the session data to form query term sequences, and then inputting the query term sequences into a deep learning network to embedding each term in a multidimensional vector in which related terms are found close to one another.

The system and methods described previously provide recognizable benefits over conventional query rewriting. In particular, the described system and methods provides for a deep learning model that learns representations of queries that compactly capture information on how often they appear within similar contexts. The model provides a flexible learning method, allowing fine tuning of representations for various tasks of critical interest to search engine companies (e.g., rewrite specialization, rewrite generalization, optimization of improving bid term coverage and click-through rates). The embedding of queries into the compact vector space enables efficient retrieval of rewrites using standard tree-based spatial data structures.

From the foregoing, it can be seen that the present disclosure provides systems and methods for rewriting queries without having to rely on co-occurring terms. While various embodiments have been described above, it should be understood that they have been presented by way of example only, and not limitation. It will be apparent to persons skilled in the relevant arts) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A computing system for rewriting queries, comprising:
an input module configured to receive a plurality of queries and session information for each of the queries;
a learning module configured to embed terms contained in the plurality of queries in a multidimensional word vector, wherein terms having a similar context in a session are near each other in the multidimensional word space; and
a query rewrite module configured to receive a query, find the nearest neighbors of terms within the query in the multidimensional word vector, and rewrite the query with the nearest neighbors of the term.

2. The computing system of claim 1, wherein the plurality of queries and session information comprise at least one document consisting of a string of uninterrupted queries ordered temporally by a user.

3. The computing system of claim 1, wherein the nearest neighbor is found using a cosine distance metric.

4. The computing system of claim 2, wherein a string of uninterrupted queries is defined as an uninterrupted sequence of web search activity by a user that ends when the user is inactive for more than 30 minutes.

5. The computing system of claim 1, wherein input module is further configured to group queries among the plurality of queries into documents comprising a string of uninterrupted queries ordered temporally by a user.

6. The system of claim 1, wherein the learning module operates on the plurality of word sequences in a sliding window fashion.

7. The system of claim 1, wherein each sequence of words is a context.

8. A method for rewriting queries, comprising:
accessing a history of search query activity to obtain a plurality of queries and session data;
grouping queries from among the plurality of queries into documents, with all queries in a document having a common session;
inputting the documents into a deep learning network to embed terms from among the queries in a multidimensional word vector in which related terms are found close to one another;
receiving an input query;
locating terms in the input query within the multidimensional word vector;
finding a plurality of nearest neighbor terms to the input terms in the multidimensional word vector; and
rewriting the input query into a modified query containing the plurality of nearest neighbor terms.

9. The method of claim 8, wherein finding a plurality of nearest neighbor terms comprises determining nearest neighbors through a cosine distance metric.

10. The method of claim 8, wherein the multidimensional word vector has greater than 200 dimensions.

11. A computer program product for rewriting queries, the computer program product comprising non-transient computer readable storage media have instructions stored thereon that cause a computing device to perform a method comprising:
receive a query comprising a query term;
access a multidimensional word vector of interconnected query words to find a plurality of related query words spatially near the query in the multidimensional word vector;
rewrite the query with the plurality of related words.

12. The computer program product of claim 11, wherein the multidimensional word vector comprises an output of a deep learning network trained with a plurality of word sequences with each word sequence comprising query terms from a continuous query session.

13. The computer program product of claim 12, wherein the instructions further cause the computing device to build the multidimensional word vector.

14. The computer program product of claim 13, wherein building the multidimensional word vector comprises:
collecting a plurality of query terms having associated session data;
grouping query terms from among the plurality of query terms according to session data to form term sequences;
inputting the term sequences into a deep learning network to embed each term in a multidimensional word vector in which related terms are found close to one another.

15. The computer program product of claim 11, wherein the query comprises a multi-word phrase.
